(19) United States
(12) Patent Application Publication
(10) Pub. No.: US 2024/0370858 A1
(43) Pub. Date: Nov. 7, 2024

(54) APPARATUS, SYSTEMS AND METHODS FOR PROCESSING TRANSACTIONS

(71) Applicant: Parking BOXX Corp., Milton (CA)

(72) Inventor: Renee Smith, Milton (CA)

(21) Appl. No.: 18/655,129

(22) Filed: May 3, 2024

Related U.S. Application Data
(60) Provisional application No. 63/593,460, filed on Oct. 26, 2023.
(60) Provisional application No. 63/464,236, filed on May 5, 2023.

(51) Int. Cl. G06Q 20/38; G06Q 20/32

(52) U.S. Cl. CPC G06Q 20/3821; G06Q 20/3274

(57) ABSTRACT

The disclosed apparatus, systems and methods relate to a transaction system for one touch transaction processing for use in secured access. The transaction system features a kiosk and/or cloud server that are configured to generate a unique credential having a unique code with embedded information for use by the end user via a mobile device to complete the transaction in a single interaction. The system can also feature certain back end processing improvements and failsafe systems for improved uptime and operability.

### CROSS-REFERENCE TO RELATED APPLICATION(S)

This application claims priority to U.S. Provisional Application No. 63/464,236 filed May 5, 2023, entitled “APPARATUS, SYSTEMS AND METHOD FOR PROCESSING TRANSACTIONS VIA UNIQUE CREDENTIALS”, and to U.S. Provisional Application No. 63/593,460 filed Oct. 10, 2023, entitled “APPARATUS, SYSTEMS AND METHOD FOR PROCESSING TRANSACTIONS VIA UNIQUE CREDENTIALS”, both of which are hereby incorporated by reference in their entirety.

### TECHNICAL FIELD

The disclosed technology relates generally to the processing of transactions, such as time-related transactions via the issuance and use of unique credentials.

### BACKGROUND

Time based payments for a secure area (i.e. admission into an event area or parking lot with gates where a user may not go in and out freely due to a locked door, barrier, fence, capacity limits, payment requirement, and the like) may require many steps ((1) go to website or scan a QR code, (2) download an app, (3) sign in, (4) scan another QR code, etc.) or at a minimum scanning multiple QR codes, which can be confusing and time consuming for the end user.

Thus, there is a need in the art for improved systems, devices, and methods for the processing of transactions including payments for time-based entry into service areas.

### BRIEF SUMMARY

Discussed herein are various devices, systems, and methods relating to a transaction processing and validation. Various implementations relate to the devices, methods, and systems allowing the use of a credential to enable one-touch or one-step transactions, such as time-based venue or parking transactions.

To ensure entry into a secure (service) area, rather than downloading one or more apps, waiting in queue to pay, or similar time consuming and/or cumbersome alternatives, the disclosed system provides for receiving a credential from a kiosk (i.e. a digital or printed ticket from a kiosk). The service area can be various enclosed or secured areas, such as for parking or gathering, where admission and leaving of patrons is done in a controlled manner.

In the various examples described herein, a system of one or more computers can be configured to perform particular operations or actions by virtue of having software, firmware, hardware, or a combination of them installed on the system that in operation causes or cause the system to perform the actions in these examples and implementations. One or more computer programs can be configured to perform particular operations or actions by virtue of including instructions that, when executed by data processing apparatus, cause the apparatus to perform the actions.

In Example 1, a transaction system comprising a device configured to generate unique credentials comprising a unique code having embedded information and a cloud server configured to receive the embedded information from a mobile device and transmit transaction validations to the kiosk.

Example 2 relates to the transaction system of any of Examples 1 and 3-7, wherein the unique code is a QR code.

Example 3 relates to the transaction system of any of Examples 1-2 and 4-7, wherein the embedded information resolves to a specific URL and contains transaction information.

Example 4 relates to the transaction system of any of Examples 1-3 and 5-7, wherein the system is configured to allow a user to scan a unique credential via a mobile device and input service input and payment information to complete the transaction via a single interaction.

Example 5 relates to the transaction system of any of Examples 1-4 and 6-7, further comprising a kiosk monitoring and self-resolving system.

Example 6 relates to the transaction system of any of Examples 1-5 and 7, wherein the kiosk and/or the cloud server are configured to generate a unique credential corresponding credential record, sync the credential record to the cloud server, receive service input and payment information, and complete the transaction.

Example 7 relates to the transaction system of any of Examples 1-6, wherein to complete the transaction, the system is further configured to verify the service input and payment information with the credential record and process a payment from stored payment information.

In Example 8, a transaction system for use by a user for use of a services area over a period of time having a beginning and an end, comprising at least one kiosk configured to generate unique credentials comprising codes having embedded information and a cloud server configured to receive the embedded information from a mobile device and transmit transaction validations to the kiosk, wherein the system is configured to: generate a unique credential having a credential record at the kiosk; sync the credential record to the cloud server; and receive service input and payment information from the user between the beginning and end of the time that the user is using the services area; and complete the transaction at the end of the time.

Example 9 relates to the transaction system of any of Examples 8 and 10-14, wherein to complete the transaction, the system is further configured to verify the service input and payment information with the credential record: and process a payment from stored payment information.

Example 10 relates to the transaction system of any of Examples 8-9 and 11-14, further comprising a kiosk monitoring and self-resolving system.

Example 11 relates to the transaction system of any of Examples 8-10 and 12-14, wherein the system comprises a plurality of kiosks.

Example 12 relates to the transaction system of any of Examples 8-11 and 13-14, wherein a back-end operator interface is configured to display the plurality of kiosks on a single screen.

Example 13 relates to the transaction system of any of Examples 8-12 and 14, wherein the system further comprises a back-end operator interface.

Example 14 relates to the transaction system of any of Examples 8-13, wherein the kiosk further comprises a kiosk fee calculator.

In Example 15, a transaction system for use by a user for use of a services area over a period of time having a beginning and an end, comprising at least one kiosk configured to generate unique credentials comprising codes having embedded information, a cloud server configured to receive the embedded information from a mobile device and transmit transaction validations to the kiosk, a back-end operator interface, and a kiosk monitoring and self-resolving system, wherein the system is configured to generate a unique credential corresponding to a credential record at the kiosk; receive service input information and payment information from the user between the beginning and end of the period of time that the user is using the services area; and complete the transaction at the end of the period of time.

Example 16 relates to the transaction system of any of Examples 15 and 17-20, wherein to complete the transaction, the system is further configured to verify the service input and payment information with the credential record: and process a payment from stored payment information.

Example 17 relates to the transaction system of any of Examples 15-16 and 18-20, wherein the user further provides the service input information and payment information using a mobile device.

Example 18 relates to the transaction system of any of Examples 15-17 and 19-20, wherein the mobile device is directed to a screen to submit the service input information and payment information upon scanning the unique credentials and/or codes.

Example 19 relates to the transaction system of any of Examples 15-18 and 20, further comprising an access barrier.

Example 20 relates to the transaction system of any of Examples 15-19, wherein the access barrier is opened upon completion of the transaction.

Other implementations of these examples and the others described herein include corresponding computer systems, apparatus, and computer programs recorded on one or more computer storage devices, each configured to perform the actions of the methods.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a schematic view of an exemplary embodiment of the system architecture, according to one implementation.

FIG. 2A is a flow chart showing steps for executing system, according to one implementation.

FIG. 2B is a flow chart showing operational steps executing the system, according to one implementation.

FIG. 2C flow chart showing operational steps for executing the system, according to one implementation.

FIG. 3A shows an operator interface, according to one implementation.

FIG. 3B shows an operator interface, according to one implementation.

FIG. 4 depicts a decision tree and steps for a self-resolving system, according to one implementation.

FIG. 5 depicts one a decision tree and steps for a predictive analytics system for resource allocation, according to one implementation.

### DETAILED DESCRIPTION

The various implementations disclosed or contemplated herein relate to a transaction/payment system 1. In certain implementations, the system 1 allows for a one-touch transaction process for resource allocation and/or entry into a service area. The system 1 issuing a unique credential to a user, and through various steps described herein, allowing for a user to enter/use particular services for a period of time. Various alternative use cases for the system 1 are possible and would be appreciated.

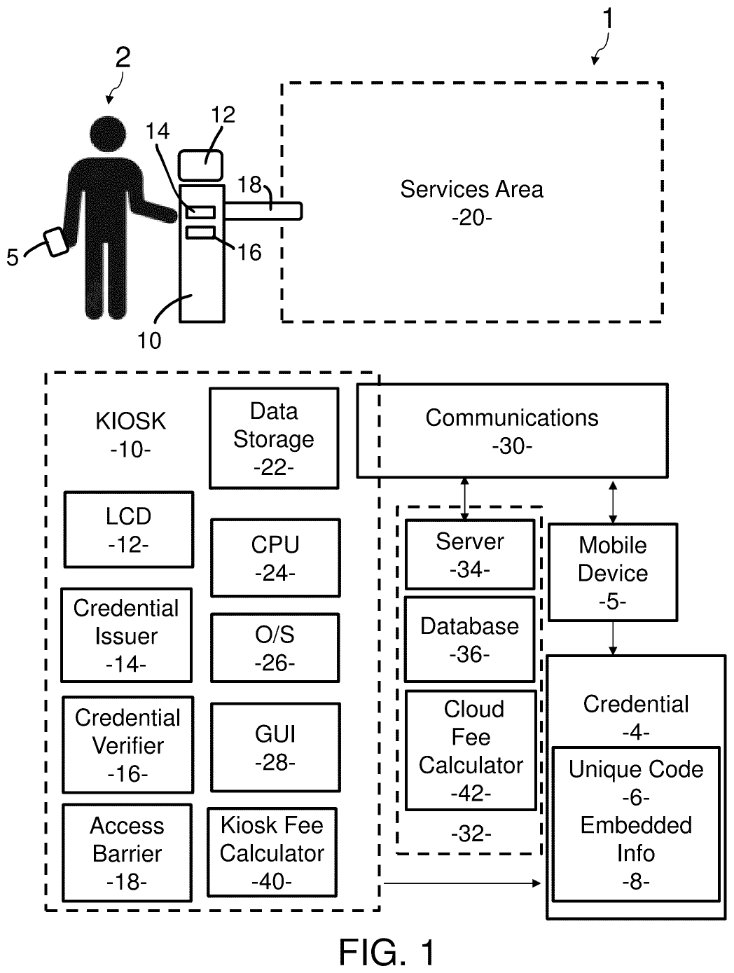

FIG. 1 depicts an overview of the payment system 1, according to certain implementations. In various implementations, a kiosk 10, terminal 10, or the like is provided that a user 2 is able to interact with in conjunction with the use of/access to a service area 20, optionally a restricted/secured services area 20. Examples of a service area 20 include a parking lot, parking ramp, event venue, or other area having limited/restricted/secured access. Certain implementations can be configured for use in a variety of settings/situations, such as admission into an event or venue (i.e. aquarium, art exhibit, zoo, park, and the like), optionally where is there limited occupancy, such as due to fire or health codes. The system 1 may optionally be implemented where there is a need for motivation to move users through to an exit by charging a time-based fee to incentivize exit. The various implementations of the system 1 allow an administrator/venue to quickly admit users and motivate conservation of time in the venue, thus allowing the venue to collect more revenue in the aggregate.

According to certain implementations, the system 1 issues a user 2 a time-based credential 4 having a unique code 6 for use in completing a transaction in a single interaction via a device 5, optionally a mobile device 5 such as a cell phone, tablet, or the like. The mobile device 5 is equipped to process certain embedded information 8 in the unique code 6, as would be readily understood and appreciated. In various implementations, the unique code 4 can take the form of a QR code, a bar code, or any other scannable code or unique identifier that would be understood by those in the art. For example, it is readily understood that smart phones are equipped with relevant software and hardware to scan an interpret QR codes for redirecting to web based or other assets.

In certain implementations, the system 1 comprises a kiosk 10 configured to both generate and read the credential 4 to effectuate the processes of the system 1 described herein. Accordingly, the kiosk 10 may include a variety of hardware and software components for use in effectuating the functions and processes related to the generation and use of the credential 4.

As such, in implementations like those of FIG. 1, the kiosk 10 comprises components such as a screen 12, optionally a touch screen, an LCD screen, or the like, a credential issuer 14, and a credential verifier 16. It is further appreciated that in these and other implementations, the kiosk 10 optionally features an access barrier 18, such as a raisable bar, releasable gate, turnstile, door, or other barrier that is in operational communication with the kiosk 10 and/or system 1 generally. As would be readily understood, the access barrier 18 may serve to control access to the service area 20.

The kiosk 10 may include further optional computing and processing components, including for example a data storage system 22, a CPU 24, an operating system 26, a graphical user interface 28, a communications unit 30, and other software, hardware, and firmware necessary to effectuate the systems and processes described herein. Various portions of the kiosk 10 may be cloud based, virtual, or otherwise remote from the physical kiosk station. It is understood that in various implementations the communications unit 30 is configured for one or more wired or wireless connections, including LAN connections (not shown), such as with other kiosks and local components and with a cloud component 32. In various implementations, the cloud component 32 can comprise a variety of components, including but not limited to a server 34, one or more databases 36, a fee calculator 42, various processors, and the like. As would be understood, information stored or processed through a cloud component 32 can be said to be in the cloud 32 or on a cloud server 34.

Various implementations of the system 1 may further comprise an optional fee calculators, such as a kiosk fee calculator 40 and/or a cloud fee calculator 42, as will be discussed in further detail herein.

In use according to certain implementations, the system 1 allows the user 2 to use a mobile device 5 a single time to transmit all of the necessary information to the system 1, and optionally to a cloud server 34 and database 36, for later access at the kiosk 10 to complete the transaction. That is, in exemplary implementations of the system 1, the user 2 is able to collect and/or be assigned the credential 4, optionally printed onto a ticket or slip of paper or digitally printed/given. Upon entry into the secured area 20, the user 2 may scan or otherwise interact with the credential 4 and enter one or more pieces of information—such as a duration and a payment method—into the system 1, optionally for upload to the cloud 32. The user 2 may then complete the transaction at exit of the secured area 20 by returning or scanning the credential 4 again at the exit (optionally at a kiosk 10).

The system 1 saves the user 2 from having to perform multiple scanning or mobile device interactions prior to exit from the secured area 20. That is, the user 2 is provided with time between receiving the credential 4 and exiting the secured area 20 with which to execute the one-touch transaction described herein. Optionally, the user 2 may execute certain transaction processing step after exiting the secured area 20.

Further, in certain implementations of the system 1—because the credential 4 and unique code 6 is embedded with sufficient information to identify that specific credential 4 and direct the user 2 to the transaction payment URL, application, platform, portal, or the like—the system 1 need not require the creation of an account or other personal identifying information. Further advantages of the system 1 will be apparent from the accompanying disclosure.

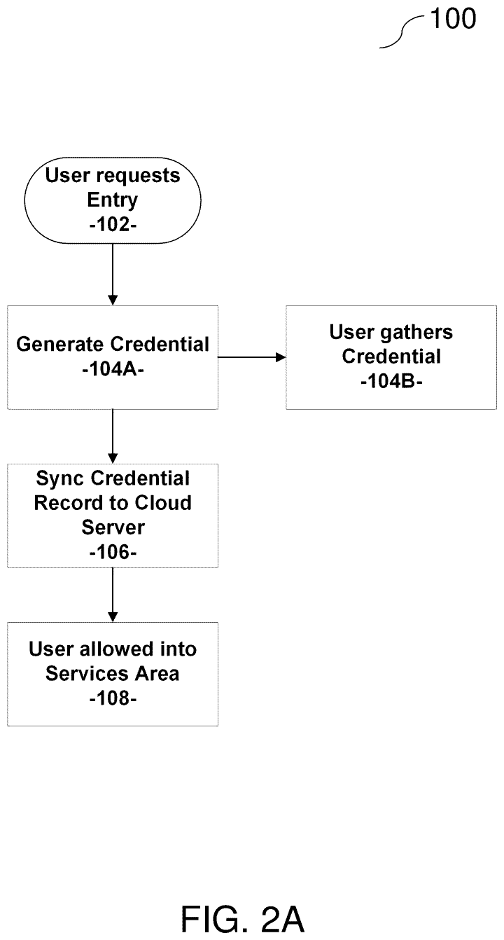

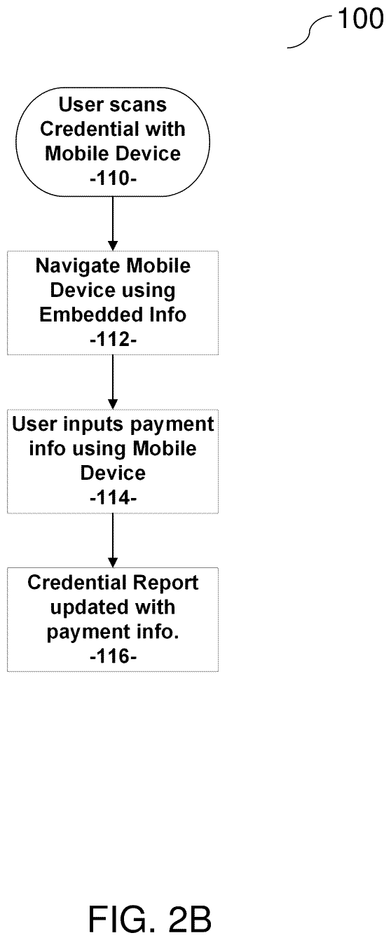

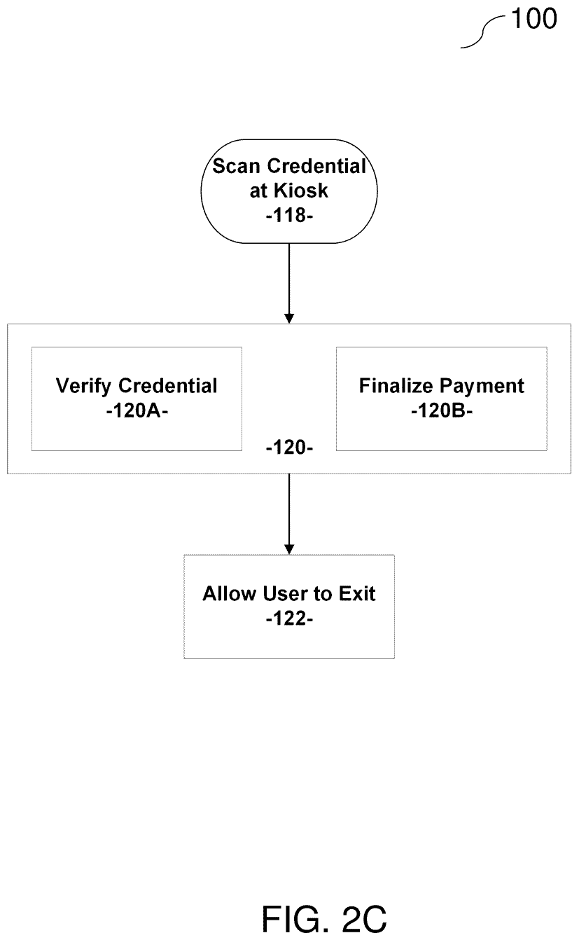

In use according to certain implementations like that of FIG. 2, upon entry into a secure services area 20, a user 2 receives a credential 4, such as a unique credential 4 including a unique code 6 that contains certain embedded information 8. For example, the unique code 4 may be a QR Code 6. In various implementations, the credential 4, and/or unique code 6 is encrypted to prevent modification, manipulation, or the like, as would be understood by those of skill in the art.

FIGS. 2A-2C depict flow diagrams demonstrating various steps for execution of and use of the system 1, according to certain implementations. It would be understood that the system 1 includes a variety of optional steps and sub-steps that may be performed in any order or not at all. The various steps and sub-steps can be performed sequentially, simultaneously, iteratively, or not at all.

Turning to FIG. 2A, in a first optional step, a user 2 requests entry to the services area 20 (box 102). In various implementations, this can be accomplished by the user 2 interacting with a kiosk 10, such as, through a graphical user interface 26 or a button on the kiosk 10, though other methods of interaction are possible. In another optional step, the system 1 generates a credential 4 (box 104A) in response to a user 2 requesting access to the secured area. In some implementations, the credential 4 can be a ticket that is easily portable, such as a printed QR or bar code.

Optionally, in another step, the user 2 may gather the credential 4 (box 104B). The user 2 may then take the credential 4 into the services area 20 upon entry (box 108).

After the credential 4 is generated, in another optional step, the kiosk 10 may synchronize the credential record corresponding to the generated credential 4 to the cloud server 32 through the communications unit 30 (box 106).

Optionally, once the credential record is synchronized with the cloud server 32, the system may allow entry into the services area 20 (box 108) such as by opening the access barrier 18.

Turning now to FIG. 2B, in another optional step, the user 2 may scan or otherwise interact with the credential 4 and/or the unique code (box 110)

In a further optional step, the unique code 4 may direct the user 2 to a system 1 portal, webpage, app or other processing system (box 112). For example, a QR code 4 may be scanned by a mobile device 5 to direct a web browser to open a unique portal for the system 1. Various alternative pathways for reaching the payment/transaction portal are possible and would be understood by those of skill in the art.

The system 1 may then, optionally, direct the user 2 to enter payment information and/or other inputs into the portal or other system (box 114).

In one example, the mobile device 5 is be directed to a webpage for information input via the embedded information 8, such as a hyperlink, embedded within the unique code 6 (boxes 112 and 114). The embedded information 8, in various implementations, may contain other information, such as but not limited to transaction identifying information (a transaction ID number), the time the credential 4 was generated, and other relevant information. Inputs may include informational commands such as the desired time length of the transaction, locations, demographics, and the like.

In a further optional step, the system 1 may update the credential record corresponding to the credential 4 with the information entered by the user 2 (box 116).

In a further optional step, to complete the transaction (box 120), optionally as the user 2 exits the services area 20, the user 2 may scan the credential 4 at the kiosk 10. This may be accomplished using the credential verifier 16 or reader of the kiosk 10, or in other ways known to the art (box 118).

In another optional step, the system 1 verifies the credential (box 120A). Verifying the credential 4 (box 120A) may include determining that the credential 4 has a properly associated credential record stored on the cloud 32 (box 120A). Optionally, the system 1 may determine if the credential 3 is “open” (i.e. time is still accruing for the related transaction, or time is “running”) or is “closed” (i.e. completed) by comparing the embedded information 6 with synchronized and verified information. In these implementations, the system 1 may allow for the user 2 to exit or provide additional payment options if a pre-paid time period was exceeded.

In another optional step, or substep, the system 1 may finalize payment for the transaction (box 120B), optionally using the payment information supplied by the user 2. The payment amount for the transaction may optionally be calculated based on time elapsed between the credential 4 being generated and scanned at the kiosk 10. Optionally, the payment may be a flat rate, include surge pricing, and/or an alternative payment structure, as would be appreciated.

In various implementations, in another optional step, once the transaction is complete (box 120), the system 1 may open an access barrier 18 to allow the user 2 to exit (box 122). In other implementations, a user 2 may be allowed to freely exit (box 122) the services area and complete the transaction at their discretion. In various implementations, the user 2 is able to access a record of the transaction, such as a receipt, by utilizing the credential 4 or other information provided to or by the user 2.

In various implementations, the calculation of fees can be performed in the cloud 32, such as via a cloud fee calculator 42 application or module.

Through the use of these and other implementations, the system 1 allows for a one touch interaction with a mobile device. That is, as an example, if the user 2 inputs a duration into the system 1 when they scan the unique code 6 on the credential 4 and submit payment, when the credential 4 is subsequently verified prior to exit. So long as the duration does not exceed the inputted value and payment details have been secured, the user 2 is able to exit the secured area having only interacted with their mobile device 5 once during the transaction. In various implementations, the duration may be automated to be the current time or an hour from the current time, or a set of options of future times, as would be appreciated. In certain implementations, there may be no need for a duration to be specified by the user 2 in advance as it may be an automated value.

As described above, the credential verifier 16 according to various implementations can look up/retrieve certain embedded information 6 on the cloud 32 and/or server 34, and any necessary inputted user data for payment. Certain implementations of the system 1 may include a redundancy system to address intermittent interruptions to communications between the kiosk 10 and cloud 32. That is, for example, if the issuing kiosk 10 is off-line, the unique code 4 still contains all needed information embedded to find status and payment, such as, the credential 3 location, a valid start time, a valid end time, fee rules, and the like, which can be calculated locally, such as via a kiosk fee calculator 40 so as to allow for at-kiosk payment such as via the GUI 28 in the event of a communications issue or at a user 2 or operator option. Various implementations apply rate logic to determine current and future payment options at the fee calculator 40, 42, as would be understood.

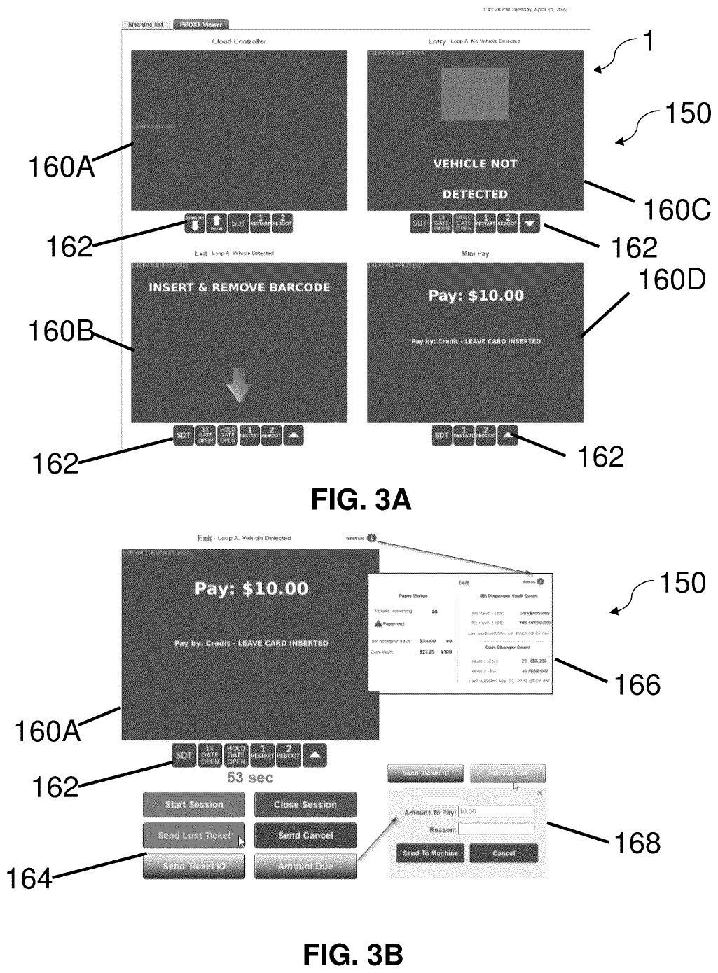

FIG. 3A depicts an operator interface 150 of the system 1, according to certain implementations. It is appreciated that the back-end operator interface 150 according to these implementations is configured to allow a single operator or team of operators to monitor and operate several kiosks 10 in a single location to maximize uptime, troubleshoot, run diagnostics, and generally maximize ease of use by the users and operators.

In these implementations, an operator is able to simultaneously view status screens (160A, 160B, 160C, 160D) for each of the kiosks 10 in a network. It is appreciated that these status screens 160A, 160B, 160C, 160D can be individually selected for interaction, and that in these implementations the interface 150 can further provide a plurality of action buttons 162 that allow the operator to interact with the kiosks 10 remotely to perform a variety of remote operations, such as raising and lowering the barrier 18, running a self-diagnostic test (SDT), restarting the system, rebooting the system, and/or performing a power cycle, as would be appreciated.

In FIG. 3B, an individual kiosk screen 160 has been accessed on the system 150 for further use. In these implementations, additional options 164 may be performed by the user 2, and individual information 166 and operation 168 windows may be accessed, as would be understood depending on the use case.

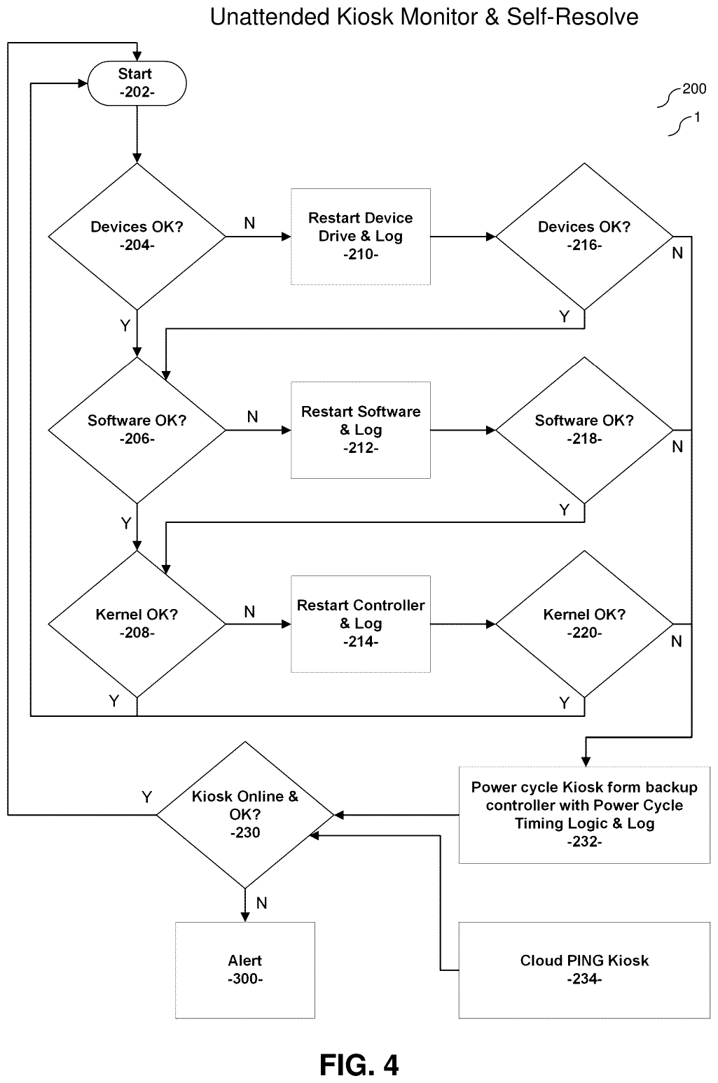

It is appreciated that for users 2 paying via a cloud-based system who are then subsequently interacting with equipment/hardware, it is imperative that the updated payment data is received by the kiosk 10, otherwise the user 2 will be required to pay again or reenter payment details further extending the transaction. Accordingly certain implementations of the system 1 utilize a kiosk monitoring and self-resolving system 200, one implementation of which is shown in FIG. 4.

Certain implementations of the system 1 utilize a primary controller kernel monitor algorithm to monitor uptime and/or self-resolve. Certain implementations utilize a second controller to determine if the primary controller is unresponsive, and to issue a full kiosk power cycle to the power relay device with optimized sequencing to minimize power cycle time but ensure the proper power sequence of components. In certain implementations, the system 1 is configured to display historical data offline time in graphical format.

In certain implementations like that of FIG. 4, the system 1 self-resolving system 200 proceeds through a number of optional steps and sub-steps to verify communications and maintain connectivity. In the example workflow of FIG. 4, the system 200 starts (box 202) and then queries if the devices are operating (box 204), if the software is operating (box 206), and if the kernel is operating (box 208).

In the event that the devices are not operating, the device driver and log are automatically restarted and the issue noted and logged (box 210).

In the event that the software is not operating, the software is automatically restarted and the issue noted and logged (box 212).

In the event that the kernel is not operating, the controller is automatically restarted and the issue noted and logged (box 214).

Following any such restart, the system subsequently revalidates the devices (box 216), software (box 218), and/or kernel (box 220) as appropriate. In the event that the issue persists, the system 200 then proceeds to power-cycle the kiosk 10 from a backup controller with power timing logic and the issue noted and logged (box 232).

In a subsequent step, the kiosk is queried (box 230) to determine if it is operational, and if not, an alert (box 300) is issued, such as an email alert or other notification to the system administrator and/or other operator. In certain implementations, the kiosk 10 can also be queried via a cloud ping (box 234). In various implementations, these pings can be scheduled to occur at a regular frequency, such as about three times per every fifteen minutes, or as dictated by the system administrator at nay designated frequency.

Upon receipt of the alert, the system administrator is then able to dispatch a technician to the kiosk 10 to power cycle or troubleshoot to determine the best course of action to resolve the issue.

Certain additional actions are taken in various implementations to ensure optimal performance and uptime, in conjunction with the above process. These can include automated daily software restarts, automated weekly kiosk 10 power cycling, performing automated interim software restarts if indicated by algorithms, performing automated component power cycle of components if algorithms indicate component or driver issues, and syncing data from cloud 32 to kiosk 10. Further options are of course possible.

In various implementations, the system 1 is able to assist in monitoring and optimizing revenues for locations where space may be limited, for example parking lots. As would be appreciated, finding overnight parking for large vehicles (e.g. semi-trucks, recreational vehicles (RVs)) can be difficult. While there are a large number of these large format vehicles on the road, there are a limited number of appropriate parking sports, and drivers of these vehicles often have a limited number of hours they can drive in a day (limiting range). Further, the drivers and owners of these vehicles prefer to have legal, safe parking which can be difficult to find given the limitations and parameters.

Additionally, for locations with overnight parking spaces that may be used be large format vehicles, the assigning, monitoring, and optimizing of revenue for the operator of the location can be labor intensive and challenging.

Due to travel delays, scheduling changes, and other variables, finding or making reservations for overnight large vehicle parking may need to happen en route and/or last minute. When completing searches for spaces, it is helpful that available options are presented concisely with most preferred result(s) at the top of the search results. Optionally, a driver may set preferences for: services available at a location, size of a location, distance from highway/services, distance from user, and other preferences, as would be understood.

When driving or travelling, it is challenging to read dozens of options, find needed features, and/or compare pricing. Accordingly, there is great value in receiving a preferred result or two, or an otherwise ranked list. This is more efficient, less time consuming, and results in better, faster user experience that may be optimized for voice interaction while driving.

In various implementations, the system 1 may be implemented to assess the current resources, assign weighted values to determine priorities, assign a parking space, offer upgrades and/or specials to optimize revenue, ensure optimal traffic flow, and improve end user experience.

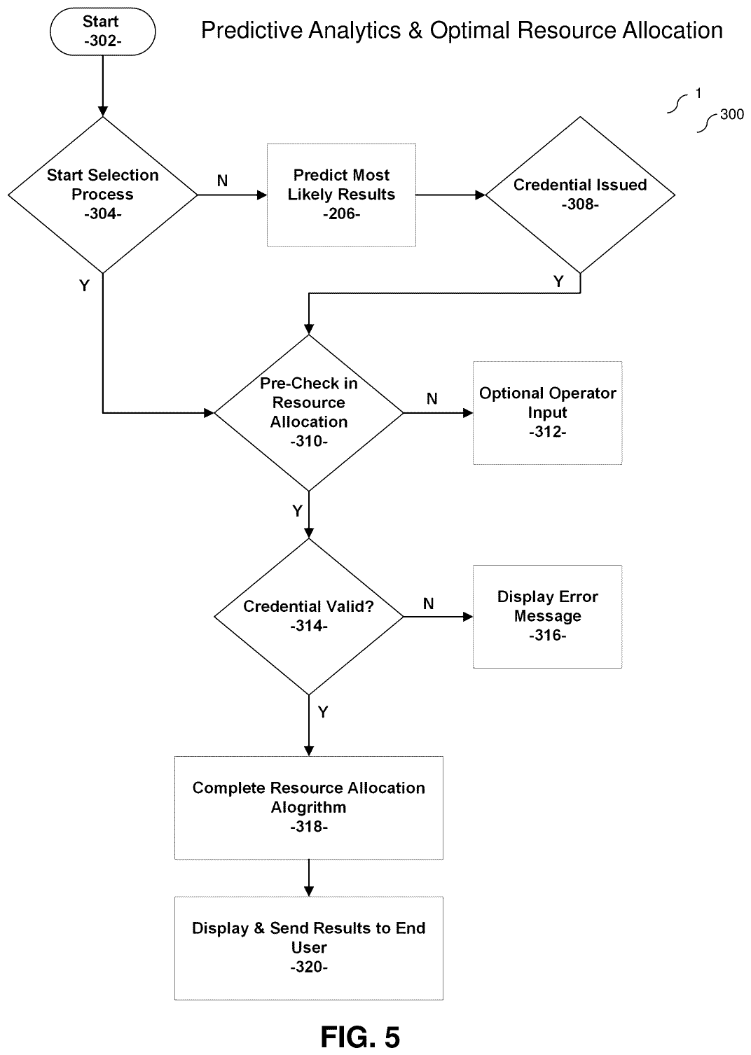

FIG. 5 shows an exemplary implementation of a predictive analytics system 300 for resource allocation, the predictive analytics system 300 is part of the system 1 discussed above. In various implementations, the system 1 utilizes the predictive analytics 300 to prioritize likely selections and recommend locations, spaces, and/or packages based on one or more of: past behavior, distance and direction traveled, destination, time of rest, favorite foods, and preferred features. Optionally, the predictive analytics 300 can also include current data, including but not limited to location, time, date, weather, maximum daily miles/drive time, current miles/drive time, and the like. The system 300 may also utilize data regarding available resources, percent availability, and frequency of availability, and corporate booking policies.

In various implementations, automated resource allocation and prioritization is based upon: physical space (including vehicle resource space and size: bobtail, double, 53′, RV Class, etc.); travel in/out; current availability; time of departure (preference to sleep in); multi-night stay; estimated arrival rime for current reservations; historical traffic at location; driver preferences, including, nearness of services (shower, dog walk, restaurant), VIP Area, price; driver/corporate loyalty, benefits, perks; purchased upgrades; and other as would be understood.

In certain implementations, prior to entry into the services area 20 the user 2 may be presented with selections and recommendations for resource credentials, based on predictive analytics that may include: past behavior including distance and direction traveled, destination, time of rest, favorite foods, preferred features, current data, end user 2 location, time date, weather, maximum daily miles/drive time, current miles/drive time, available resources, percent availability, frequency of availability, corporate booking policies, and the like.

At or near the services area 20 the user 2 presents a credential 4 that is then scanned at a manned or unmanned kiosk 10.

Once the credential 4 is determined to be valid, such as by a verifier 16, for that location, time, and date then resource(s) are allocated for a specific duration based on: physical space availability (bob tail, 53′, double, RV class, etc.), vehicle characteristics (bob tail, 53′, double, RV class, etc.), driver preferences (near eatery, near showers, price), reservation features (VIP area, time of departure (sleep-in/late check out)), driver/corporate loyalty benefits or perks, purchased upgrades, historical data, and the like.

Optionally, after scanning of the credential 4 the kiosk 10 may visually display allocated resources to the user 2 and optionally send information on the resources to the user 2. The user 2 may optionally allow a GPS confirmation of resource usage to assist with enforcement, as will be discussed further herein.

After checking in and/or allocation of resources, the system 1 can update resource allocation count and indicate the booking of resources.

In advance of a user 2 arrival in the service area 20, the system 1 may optionally present options to the paid service area 20 operator to confirm or approve advance resource allocations based on upcoming credentials.

Before exiting, the user 2 may complete a one-step credential 4 transaction, such as was discussed above in relation to FIGS. 2A-C. At exit of the services area 20, the kiosk 10 verifies the credential 4 record against the requirements to grant exit from the service area 20 and/or displays the amount due if paid time-based usage of services has been exceeded.

Continuing with FIG. 5, the algorithm starts (box 302) upon user 2 activation. The selection process can then begin (box 304) optionally by a user 2 entering a desired resource, opening an application, or the like, as would be understood. If a credential 4 is not yet issued the system 300 can predict most likely results (box 306), that is, predict resources desired by a user 2. The user 2 can then select their desired resource, optionally from a prioritized list, and the system 300 can then issue a credential 3 (box 308). In implementations such as this, the credential 4 may be issued to the user 2 by sending a digital credential 4 to a mobile device 5.

When a credential 4 is issued (box 308) the system 300 may execute precheck-in resource allocation (box 310). The resource operation may then optionally execute any input (box 312), for example, confirmation of a reservation, manual perk/upgrade, etc.

At check-in, optionally at a kiosk 10, the credential 4 is validated (box 314). If the credential 4 is not valid an error message can be displayed to the user 2 (box 316). If the credential 4 is valid the system 300 can complete resource allocation (box 318). The results can then optionally be displayed and/or sent to the user 2 (box 320).

Various implementations may also include autonomous check-in and monitoring for violations. The system 300 at check in can complete the algorithm for check-in. After the completion the result can be visually displayed to the driver/user 2. Additionally or alternatively the system 300 may text or otherwise message the driver/user 2 with any needed credential 4 or information. Optionally, the system 300 may allow for GPS confirmation of final position in the parking space or other specified location, such as a camp site. In certain implementations, the system 300 can notify a parking operator of conflicts and provide information needed to monitor and enforce violations. For example, a parking operator may be notified of a late checkout, parking outside the designated space, and the like as would be understood.

Although the disclosure has been described with references to various embodiments, persons skilled in the art will recognize that changes may be made in form and detail without departing from the spirit and scope of this disclosure.

What is claimed is:

1. A transaction system comprising:
(a) a device configured to generate unique credentials comprising a unique code having embedded information; and
(b) a cloud server configured to receive the embedded information from a mobile device and transmit transaction validations to the kiosk.

2. The transaction system of claim 1, wherein the unique code is a QR code.

3. The transaction system of claim 1, wherein the embedded information resolves to a specific URL and contains transaction information.

4. The transaction system of claim 1, wherein the system is configured to allow a user to scan a unique credential via a mobile device and input service input and payment information to complete the transaction via a single interaction.

5. The transaction system of claim 1, further comprising a kiosk monitoring and self-resolving system.

6. The transaction system of claim 1, wherein the kiosk and/or the cloud server are configured to:
generate a unique credential corresponding credential record;
sync the credential record to the cloud server;
receive service input and payment information; and
complete the transaction.

7. The transaction system of claim 6, wherein to complete the transaction, the system is further configured to:
verify the service input and payment information with the credential record and process a payment from stored payment information.

8. A transaction system for use by a user for use of a services area over a period of time having a beginning and an end, comprising:
(a) at least one kiosk configured to generate unique credentials comprising codes having embedded information; and
(b) a cloud server configured to receive the embedded information from a mobile device and transmit transaction validations to the kiosk,
wherein the system is configured to:
generate a unique credential having a credential record at the kiosk; sync the credential record to the cloud server; and
receive service input and payment information from the user between the beginning and end of the time that the user is using the services area; and complete the transaction at the end of the time.

9. The transaction system of claim 8, wherein to complete the transaction, the system is further configured to:
verify the service input and payment information with the credential record: and process a payment from stored payment information.

10. The transaction system of claim 8, further comprising a kiosk monitoring and self-resolving system.

11. The transaction system of claim 8, wherein the system comprises a plurality of kiosks.

12. The transaction system of claim 11, wherein a back-end operator interface is configured to display the plurality of kiosks on a single screen.

13. The transaction system of claim 12, wherein the system further comprises a back-end operator interface.

14. The transaction system of claim 8, wherein the kiosk further comprises a kiosk fee calculator.

15. A transaction system for use by a user for use of a services area over a period of time having a beginning and an end, comprising:
(a) at least one kiosk configured to generate unique credentials comprising codes having embedded information;
(b) a cloud server configured to receive the embedded information from a mobile device and transmit transaction validations to the kiosk;
(c) a back-end operator interface; and
(d) a kiosk monitoring and self-resolving system,
wherein the system is configured to:
generate a unique credential corresponding to a credential record at the kiosk; receive service input information and payment information from the user between the beginning and end of the period of time that the user is using the services area; and complete the transaction at the end of the period of time.

16. The transaction system of claim 15, wherein to complete the transaction, the system is further configured to:
verify the service input and payment information with the credential record: and process a payment from stored payment information.

17. The transaction system of claim 15, wherein the user further provides the service input information and payment information using a mobile device.

18. The transaction system of claim 17, wherein the mobile device is directed to a screen to submit the service input information and payment information upon scanning the unique credentials and/or codes.

19. The transaction system of claim 15, further comprising an access barrier.

20. The transaction system of claim 19, wherein the access barrier is opened upon completion of the transaction.
